(19) United States
(12) Patent Application Publication
(10) Pub. No.: US 2010/0123927 A1
(43) Pub. Date: May 20, 2010

(54) IMAGE PROCESSING APPARATUS, INFORMATION PROCESSING APPARATUS, AND STORAGE MEDIUM

(75) Inventor: Hideki Hirose, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/616,666

(22) Filed: Nov. 11, 2009

(30) Foreign Application Priority Data
Nov. 18, 2008 (JP) 2008-294597

(51) Int. Cl. G06F 15/00

(52) U.S. Cl. 358/1.15

(57) ABSTRACT

An information processing apparatus for performing wireless communication with an image processing apparatus includes a specifying unit configured to designate, out of a plurality of directories stored in the information processing apparatus, an opened directory before performing wireless communication with the image processing apparatus, a receiving unit configured to receive image data from the image processing apparatus by performing the wireless communication, and a control unit configured to control the image data received by the receiving unit to be stored in the directory designated by the specifying unit.

### FIELD OF THE INVENTION

The present invention relates to an image processing apparatus, an information processing apparatus, and a storage medium.

### DESCRIPTION OF THE RELATED ART

In recent years, a scanner, a printer, and a multifunction peripheral (MFP), and so on have been disposed under a local area network (LAN) environment, and have been shared within a LAN. In the MFP, a scanner contained therein is shared by information processing apparatuses (host computers) on a network, and is used in such a form that image data read with the scanner is stored in any of the host computers on the network.

An example of a method for acquiring the image data read with the scanner by the host computer is a method for controlling a scanner in an MFP from a host computer on a network and loading read image data onto the host computer.

When the image data read with the scanner is transmitted to the host computer at a destination designated on the side of the scanner, not only an identification (ID) of the host computer at the destination (transmission destination) but also a directory at the destination or an electronic mail address must be correctly input.

In not only this case but also a case where an image file stored in a storage of the MFP is transmitted, similar issues occur in terms of designating the destination.

Examples of a conventional method for designating a transmission destination of image data read with a scanner include a method for searching a screen of an operation unit in a scanner for destination information required to transmit image data to a host computer, displaying a list of results of the search on the screen of the operation unit, and selecting the result of the search (see Japanese Patent Application Laid-Open No. 2003-274102).

A configuration in which an unnecessary key is not provided on an operation unit in a scanner has also been proposed. There has also been a configuration in which identification information of a user and a directory in which an image read with a scanner, which is previously created for each user, is to be stored are related to each other on a server, and the image is stored in the directory corresponding to the identification information (see Japanese Patent Application Laid-Open No. 9-37013).

As a method for transferring image data between apparatuses, a mechanism for establishing wireless communication at high speed between apparatuses at a close distance has been devised, as in a method discussed in Japanese Patent Application Laid-Open No. 2008-99236. If such a mechanism is applied, a user can transmit image data read with a scanner in an image processing apparatus to a notebook personal computer (PC), which can be carried, only by placing the notebook PC in the vicinity of a communication unit in the image processing apparatus.

In the method discussed in Japanese Patent Application Laid-Open No. 2003-274102, however, a destination must be designated by operating an operation unit on an image processing apparatus, and a mail address, an ID of a host computer (a host name), and a directory of the destination must be designated.

In the method discussed in Japanese Patent Application Laid-Open No. 2008-99236, identification information of the user and information representing a directory in which the image data read with the scanner is to be stored must be related to each other. When the image processing apparatus is first used, for example, the effect thereof cannot be exhibited.

In any case, when high-speed near field communication is established, as in the method discussed in Japanese Patent Application Laid-Open No. 2008-99236, it is desirable that a desired operation can be intuitively performed only by bringing the apparatuses close to each other. In the sense, it is difficult to say that a storage destination can be intuitively designated. Japanese Patent Application Laid-Open No. 2008-99236 does not refer to a specific method for transmitting the image data that has been actually read with the scanner to a desired directory in the notebook PC only by placing the notebook PC in the vicinity of the communication unit in the image processing apparatus.

### SUMMARY OF THE INVENTION

According to an aspect of the present invention, an information processing apparatus for performing wireless communication with an image processing apparatus includes a specifying unit configured to designate, out of a plurality of directories stored in the information processing apparatus, an opened directory before performing wireless communication with the image processing apparatus, a receiving unit configured to receive image data from the image processing apparatus by performing the wireless communication, and a control unit configured to control the image data received by the receiving unit to be stored in the directory designated by the specifying unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates the appearance of an image processing apparatus.

FIG. 2 is a block diagram illustrating the configuration of an image processing system.

FIG. 3 is a block diagram illustrating the configuration of a controller unit.

FIG. 4 illustrates display on a touch panel section in an operation unit.

FIG. 5 illustrates a job setting screen in the touch panel section.

FIG. 6 illustrates a send/fax setting screen in the touch panel section.

FIG. 7 illustrates a screen after selection of near field communication in FIG. 6.

FIG. 8 illustrates a screen on which a desired directory is opened in a notebook PC in a case 1 of a first exemplary embodiment of the present invention.

FIG. 9 illustrates display of a path of a directory in which image data is to be stored in a touch panel section in the case 1 of the first exemplary embodiment of the present invention.

FIG. 10 shows display indicating that image data is stored in a desired directory in a notebook PC in the case 1 of the first exemplary embodiment of the present invention.

FIG. 11 illustrates a screen on which a desired folder is selected in a notebook PC in a case 2 of the first exemplary embodiment of the present invention.

FIG. 12 illustrates display of a path of a directory in which image data is to be stored in a touch panel section in the case 2 of the first exemplary embodiment of the present invention.

FIG. 13 shows display indicating that image data is stored in a desired directory in a notebook PC in the case 2 of the first exemplary embodiment of the present invention.

FIG. 14 illustrates display of a path of a directory in which image data is to be stored in a touch panel section in a case 3 of the first exemplary embodiment of the present invention.

FIG. 15 shows display indicating that image data is stored in a desired directory in a notebook PC in the case 3 of the first exemplary embodiment of the present invention.

FIG. 16 illustrates a screen on which a plurality of desired folders is selected in a notebook PC in a case 4 of the first exemplary embodiment of the present invention.

FIG. 17 illustrates display of options of a path of a directory in which image data is to be stored in a touch panel section in the case 4 of the first exemplary embodiment of the present invention.

FIG. 18 illustrates a display screen for searching a touch panel section for a directory hierarchy in a notebook PC in the case 1 of the first exemplary embodiment of the present invention.

FIG. 19 is a flowchart illustrating processing flow in an MFP according to the first exemplary embodiment of the present invention.

FIG. 20 is a flowchart illustrating processing flow in an MFP according to a second exemplary embodiment of the present invention.

FIG. 21 is a flowchart illustrating processing flow in a notebook PC according to the first exemplary embodiment of the present invention.

FIG. 22 is a flowchart illustrating processing flow up to completion of communication connection of near field communication between an MFP and a notebook PC in an exemplary embodiment of the present invention.

FIG. 23 is a flowchart for transmitting to an MFP information relating to a storage location in a notebook PC.

FIG. 24 is a block diagram illustrating the configuration of a notebook PC.

### DESCRIPTION OF THE EMBODIMENTS

Various exemplary embodiments, features, and aspects of the invention will be described in detail below with reference to the drawings.

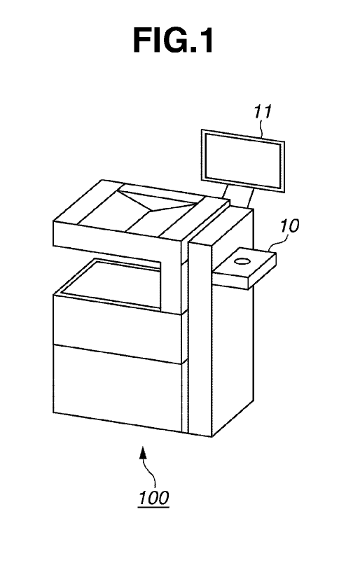

FIG. 1 illustrates the appearance of an image processing apparatus according to an exemplary embodiment of the present invention. In the present exemplary embodiment, an MFP will be described as an example of the image processing apparatus.

An MFP 100 includes a communication unit 10 and a display unit 11.

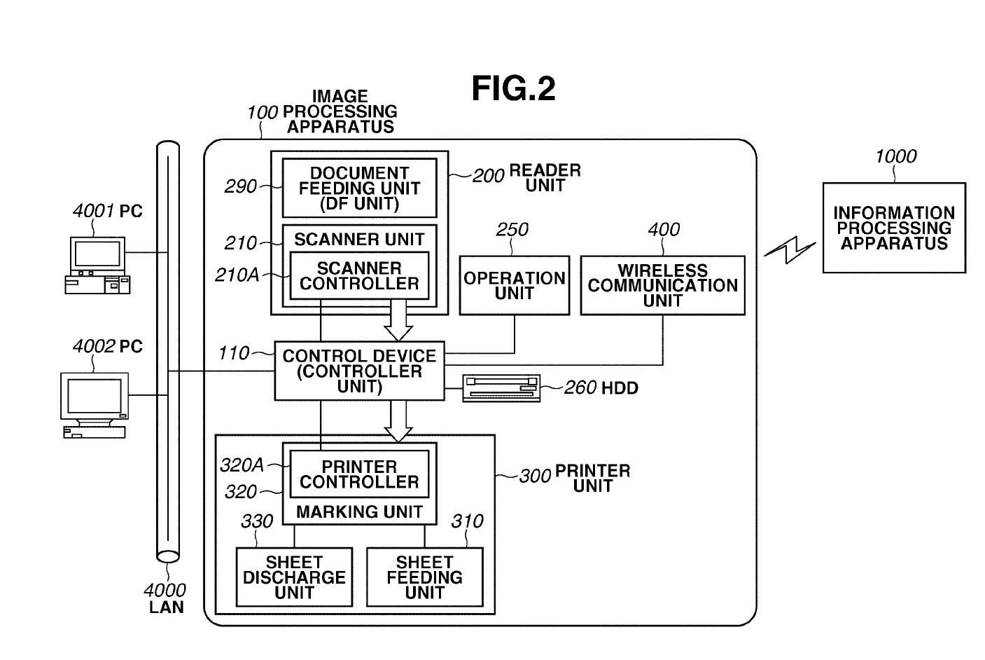

The communication unit 10 performs wireless communication with an external information processing apparatus such as a digital camera, a mobile phone, a personal digital assistant (PDA), or a notebook PC. A user brings an information processing apparatus 1000 (FIG. 2) closer to the communication unit 10, to enable communication between the MFP 100 and the information processing apparatus 1000. The MFP 100 can establish wireless communication with the information processing apparatus 1000. Although a case where the information processing apparatus 1000 is a notebook PC will be described, the present invention is not limited to the same. The information processing apparatus 1000 may be a digital camera, a mobile phone, or a PDA.

The display unit 11 includes a touch panel section and a liquid crystal display section, and displays an operation screen and accepts an instruction from the user. The display unit 11 displays the state of the MFP 100.

The configuration of an image processing system including the MFP 100 and the information processing apparatus 1000 (hereinafter referred to as the notebook PC) will be then described with reference to FIG. 2.

A controller unit 110 is electrically connected to a reader unit 200 and a printer unit 300, and receives information from the reader unit 200 and the printer unit 300 and transmits various types of commands to the reader unit 200 and the printer unit 300. The controller unit 110 is connected to PCs 4001 and 4002 via a network 4000, and transmits and receives image data and a control command from the PCs 4001 and 4002 via the network 4000. An example of the network 4000 is Ethernet.

The reader unit 200 optically reads a document image, and converts the read document image into image data. The reader unit 200 includes a scanner unit 210 having the function of scanning a document and a document feeding unit 290 for conveying document paper to a position where the scanner unit 210 can scan the document.

A scanner controller 210A controls the document feeding unit 290 and the scanner unit 210 based on an instruction from the controller unit 110.

The printer unit 300 includes a sheet feeding unit 310 accommodating sheets for printing, a marking unit 320 for transferring and fixing image data on the sheets, and a sheet discharge unit 330 for discharging the sheets on which the image data has been printed. The printer unit 300 feeds the sheets from the sheet feeding unit 310 based on the instruction from the controller unit 110, prints the image data on the fed sheets, and discharges the sheets on which the image data has been printed to the sheet discharge unit 330.

The sheet feeding unit 310 can accommodate a plurality of types of sheets. The sheet discharge unit 330 can sort and staple the sheets on which the image data has been printed.

An operation unit 250 corresponds to the display unit 11 illustrated in FIG. 1, includes a hard key, a liquid crystal display section, and a touch panel section affixed on the liquid crystal display section, and accepts an instruction from the user via the hard key, the liquid crystal display section, and the touch panel section. The operation unit 250 transmits to the controller unit 110 a command corresponding to the accepted instruction from the user. The controller unit 110 carries out control according to the received command. The operation unit 250 provides display indicating a soft key for accepting the operation of the MFP 100 and the function and the state of the MFP 100 on the liquid crystal display section.

A hard disk drive (HDD) 260 stores various types of setting for the MFP 100 and the image data. Furthermore, the HDD 260 stores a program for controlling the operation of the MFP 100.

The MFP 100 executes a copy function, an image data sending function, and a printer function, for example, using the configuration. When the copy function is executed, the controller unit 110 causes the reader unit 200 to read the image data from the document, and causes the printer unit 300 to print the read image data on the sheets. When the image data sending function is executed, the controller unit 110 converts the read image data into code data in the reader unit 200, and sends the code data to the PCs 4001 and 4002 via the network 4000. When the printer function is executed, the controller unit 110 analyzes and rasterizes the code data received from the PCs 4001 and 4002 via the network 4000, converts the code data into the image data, and outputs the image data to the printer unit 300. The printer unit 300 carries out printing based on the image data received from the controller unit 110.

Although in the present exemplary embodiment, the image processing apparatus is the MFP 100 having a plurality of functions, it may be a copying machine having only a copy function or a single function peripheral (SFP) having only a printer function.

The wireless communication unit 400 is provided in the communication unit 10, and detects that the notebook PC 1000 is brought closer to the communication unit 10 and transmits and receives control data and image data to and from the notebook PC 1000. The wireless communication unit 400 may carry out control based on the instruction from the controller unit 110. Alternatively, the wireless communication unit 400 may include a central processing unit (CPU) by itself, and the CPU may control the wireless communication unit 400.

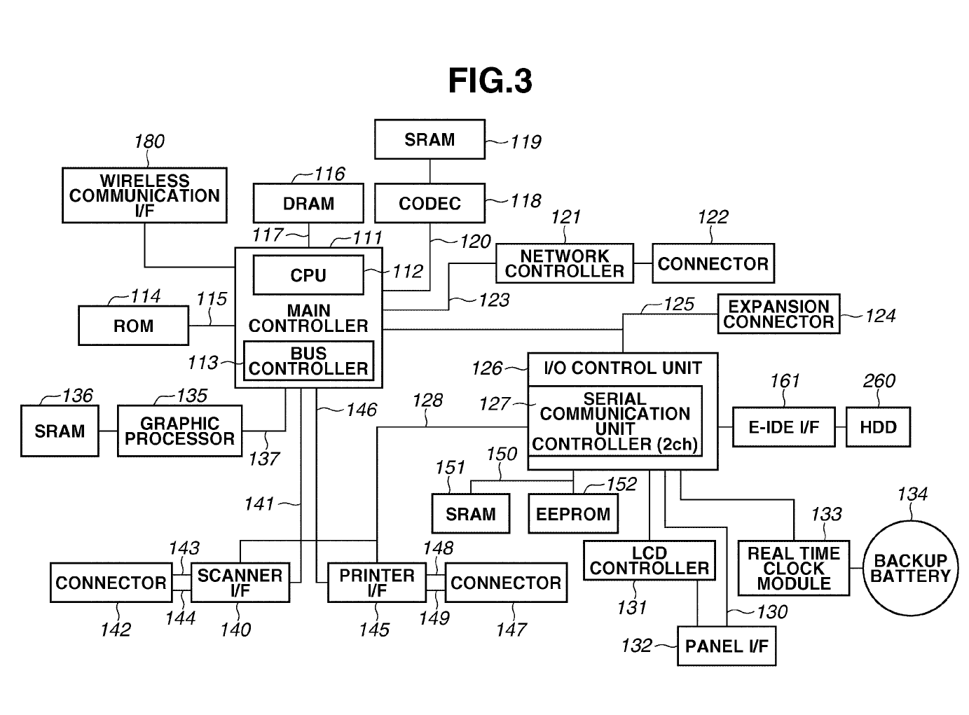

The configuration of the controller unit 110 will be then described with reference to the block diagram of FIG. 3.

A main controller 111 is mainly composed of a CPU 112, a bus controller 113, and various types of interface (I/F) controller circuits.

The CPU 112 and the bus controller 113 control the whole operation of the controller unit 110 in a supervised manner. The CPU 112 performs various types of operations based on a program read from a read-only memory (ROM) 114 via a ROM I/F 115. For example, the CPU 112 interprets the code data (e.g., a page description language (PDL)) received from the PC 4001 or 4002 illustrated in FIG. 1 and carries out storage control of a memory such as a dynamic random access memory (DRAM) 116 or the hard disk drive (HDD) 260.

The bus controller 113 controls transfer of data input or output from each of the I/Fs, and controls bus arbitration and direct memory access (DMA) data transfer.

A dynamic random access memory (DMA) 116 is connected to the main controller 111 by a DRAM I/F 117, and is used as a work area for the CPU 112 or an area for storing image data.

A codec 118 compresses raster image data stored in the DRAM 116 in a method such as MF (Modified Huffman)/MR (Modified Read)/MMR (Modified Modified Read)/JBIG (Joint Bi-level Image Experts Group)/JPEG (Joint Photographic Experts Group), while conversely expanding code data stored in a compressed state to raster image data.

A static random access memory (SRAM) 119 is used as a temporary work region for the codec 118. The codec 118 is connected to the main controller 111 via an I/F 120. Data transfer between the codec 118 and the DRAM 116 is the DMA transfer controlled by the bus controller 113.

A graphic processor 135 subjects the raster image data stored in the DRAM 116 to processing such as image rotation, image zooming, color space conversion, and binarization. The SRAM 136 is used as a temporary work region for the graphic processor 135. The graphic processor 135 is connected to the main controller 111 via an I/F 137. Data transfer between the graphic processor 135 and the DRAM 116 is the DRA transfer controlled by the bus controller 113.

A network controller 121 is connected to the main controller 111 by an I/F 123, and is connected to an external network such as the network 4000 by the connector 122.

An expansion connector 124 for connecting an expansion board and an input/output (I/O) control unit 126 are connected to a general-purpose high-speed bus 125. Examples of the general-purpose high-speed bus 125 include a peripheral component interconnect (PCI) bus. The I/O control unit 126 is equipped with asynchronous serial communication unit controllers 127 on two channels for transmitting and receiving a control command to a CPU in each of the reader unit 200 and the printer unit 300. The I/O controller 126 is connected to a scanner I/F 140 and a printer I/F 145 via an I/O bus 128.

A panel I/F 132 delivers data to the operation unit 250 illustrated in FIG. 2, and transfers to the operation unit 250 image data transferred from a liquid crystal display (LCD) controller 131. The panel I/F 132 transfers a key input signal accepted via a key such as a hard key or a liquid crystal touch panel key provided in the operation unit 250 to the I/O control unit 126 via a key input I/F 130.

A real time clock module 133 updates and stores the date and time managed within the MFP 100, and is supplied with power by a backup battery 134.

An enhanced integrated drive electronics (E-IDE) interface (I/F) 161 is used for connecting the HDD 260. The CPU 112 stores image data in the HDD 260 via the E-IDE I/F 161, and reads the image data from the HDD 260.

The connector 142 and a connector 147 are respectively connected to the reader unit 200 and the printer unit 300, and include asynchronous serial I/Fs (143, 148) and video I/Fs (144, 149).

A scanner I/F 140 is connected to the reader unit 200 via the connector 142, and is connected to the main controller 111 via a scanner bus 141. The scanner I/F 140 subjects image data received from the reader unit 200 to predetermined processing. The scanner I/F 140 outputs to the scanner bus 141 a control signal generated based on a video control signal fed from the reader unit 200. The bus controller 113 controls data transfer from the scanner bus 141 to the DRAM 116.

The printer I/F 145 is connected to the printer unit 300 via the connector 147, and is connected to the main controller 111 via a printer bus 146. The printer I/F 145 subjects image data output from the main controller 111 to predetermined processing, and outputs the image data to the printer unit 300. The bus controller 113 controls transfer of raster image data rasterized onto the DRAM 116 to the printer unit 300. The transfer of the raster image data is DMA transfer to the printer unit 300 via the printer bus 146, the printer I/F 145, and the video I/F 149.

An SRAM 151 is a memory that can hold stored contents even if power supplied from the backup battery 134 cuts off power to the whole MFP 100. The SRAM 151 is connected to the I/O control unit 126 via a bus 150.

An electrically erasable and programmable read only memory (EEPROM) 152 is also similarly connected to the I/O control unit 126 via the bus 150.

A wireless communication I/F 180 delivers data to the wireless communication unit 400 illustrated in FIG. 2. The CPU 112 receives data from the wireless communication unit 400 via the wireless communication I/F 180. The CPU 112 transfers data to the wireless communication unit 400 via the wireless communication I/F 180.

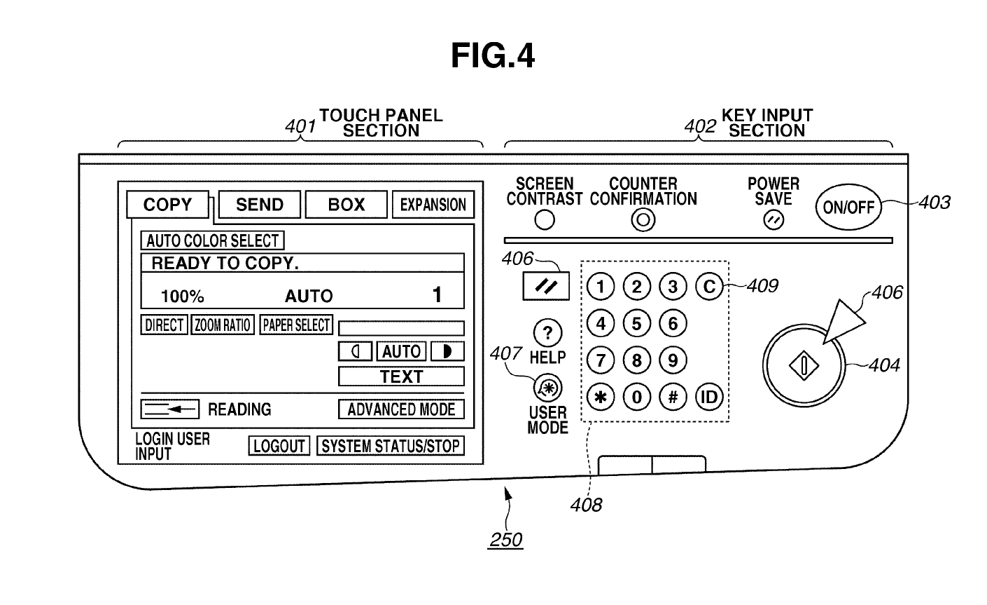

The configuration of the operation unit 250 will be then described with reference to FIG. 4.

The operation unit 250 includes a touch panel section 401 and a key input section 402.

The touch panel section 401 includes a liquid crystal display (LCD) and a touch panel display composed of a transparent electrode affixed thereon. The touch panel section 401 has the function of accepting various types of setting from the user and the function of indicating information to the user. The CPU 112 performs, when it detects that the user presses a portion corresponding to a display key displayed on the LCD, processing corresponding to the display key. An example of display on a screen displayed on the touch panel section 401 will be described below.

The key input section 402 includes an operation unit power switch 403. When the user presses the operation unit power switch 403, the CPU 112 selectively switches a stand-by mode (a normal operation state) and a sleep mode (a state where power consumption is suppressed). The CPU 112 accepts an operation by the user of the operation unit power switch 403 with a main power switch (not illustrated) for supplying power to the whole system turned on.

A start key 404 is used when an instruction to cause the CPU 112 in the MFP 100 to perform a series of operations such as an operation for scanning a document using the scanner unit 113 and an operation for printing the scanned document is accepted as a print job from the user. The start key 404 is also used when an instruction to cause the CPU 112 in the MFP 100 to perform an operation for transmitting image data stored in the HDD 260 to the exterior via the network I/F 109 is accepted as a data transmission job from the user.

A stop key 405 is used for accepting an instruction to interrupt the accepted operations as the print job from the user.

A reset key 406 is used for accepting an instruction to invalidate various types of setting made by the user for the print job and return a set value to a default state from the user.

A user mode key 407 is used for displaying a screen for making system setting for each user on the touch panel section 401.

A numeric keypad 408 is used for the user to make numeric setting for various types of setting. A clear key 409 is used for deleting an input value such as a user identification (ID) or a password that has been input by the user via the numeric keypad 408.

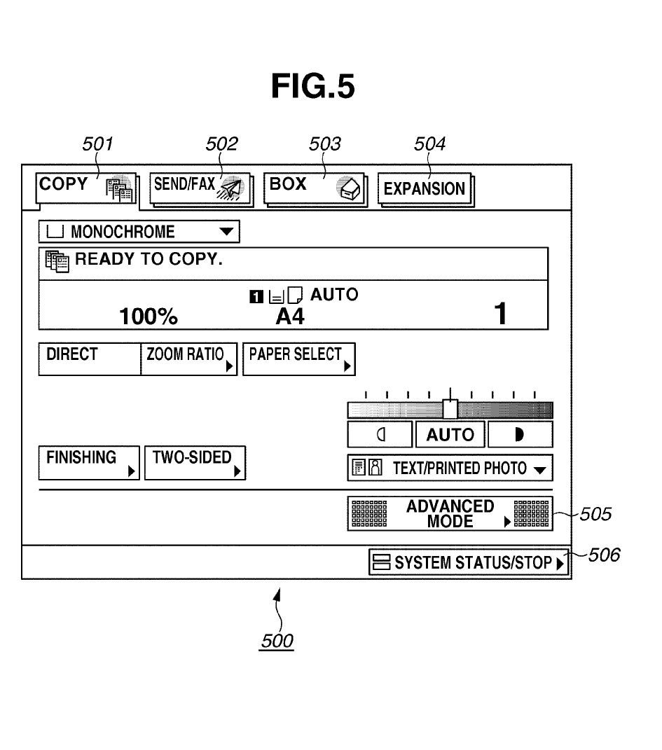

An example of a job setting screen displayed on the touch panel section 401 will be then described with reference to FIG. 5. FIG. 5 illustrates an example of the setting screen displayed on the touch panel section 401 as a default screen when the power to the MFP 100 is turned on.

When a copy key 501 is pressed, the CPU 112 displays a copy job setting screen for making setting relating to a copy job on the touch panel section 401. The screen illustrated in FIG. 5 is an example of the copy job setting screen for making the setting relating to the copy job. The CPU 112 accepts the setting of printing conditions such as the number of copies to print, printing paper, and printing magnification via the screen from the user. When the start key 404 is pressed with the setting accepted, the CPU 112 causes the scanner unit 306 to scan a document, and causes the printer unit 305 to carry out printing according to the set printing conditions.

When a send/fax key 502 is pressed, the CPU 112 displays a data sending job setting screen for making setting relating to a data sending function or a facsimile function of the MFP 100 on the touch panel section 401. The data sending function means the function of scanning a document and then converting the scanned document into image data with a predetermined format in the reader unit 200, and sending the image data to an external information processing apparatus or a server as electronic data or storing the image data in a box, described below. The details of the data sending function in the present exemplary embodiment will be described below.

When a box key 503 is pressed, the CPU 112 displays a box function setting screen for making setting relating to a box function of the MFP 100 on the touch panel section 401. The box function means that the CPU 112 stores image data read with the scanner or image data received from the exterior as a file in a storage region called a box within the HDD 260 and later prints and transmits the image data within the box based on an instruction from the user. The HDD 260 has a plurality of boxes. The user can store the image data by designating the particular one of the plurality of boxes. Alternatively, a password may be allowed to be set in each of the boxes. In the case, the CPU 112 inhibits the image data stored in the box from being displayed and inhibits the image data from being referenced and used until the set password is input to the box. The CPU 112 allows the image data stored in the box to be displayed and allows the image data to be referenced and used if the set password is input.

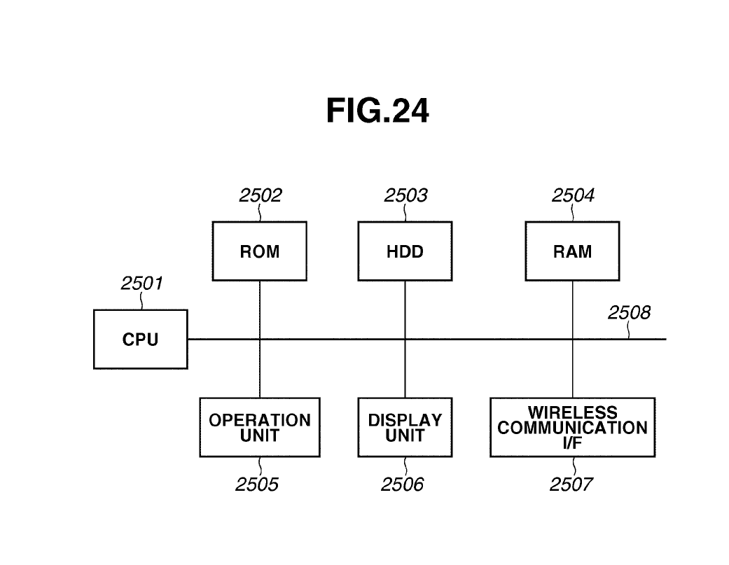

FIG. 24 is a block diagram illustrating the configuration of the notebook PC 1000.

A CPU 2501 controls the whole operation of the notebook PC 1000. A ROM 2502 stores a boot program executed by the CPU 2501. A HDD 2503 is a file system capable of storing the program executed by the CPU 2501 and further storing various types of user data such as image data in a directory structure. A RAM 2504 is used as a work area for executing the program by the CPU 2501 and an image buffer temporarily storing the image data. An operation unit 2505 issues various types of instructions to the notebook PC 1000. The operation unit 2505 is also used for the user to designate a desired folder or file from the file system. A display unit 2506 displays an operation screen and a folder or file of stored data for the user. A wireless communication I/F 2507 delivers data to the wireless communication unit 400 in the MFP 100 illustrated in FIG. 2. Communication of various types of data and commands with each of the units within the notebook PC 1000 is established via a bus 2508.

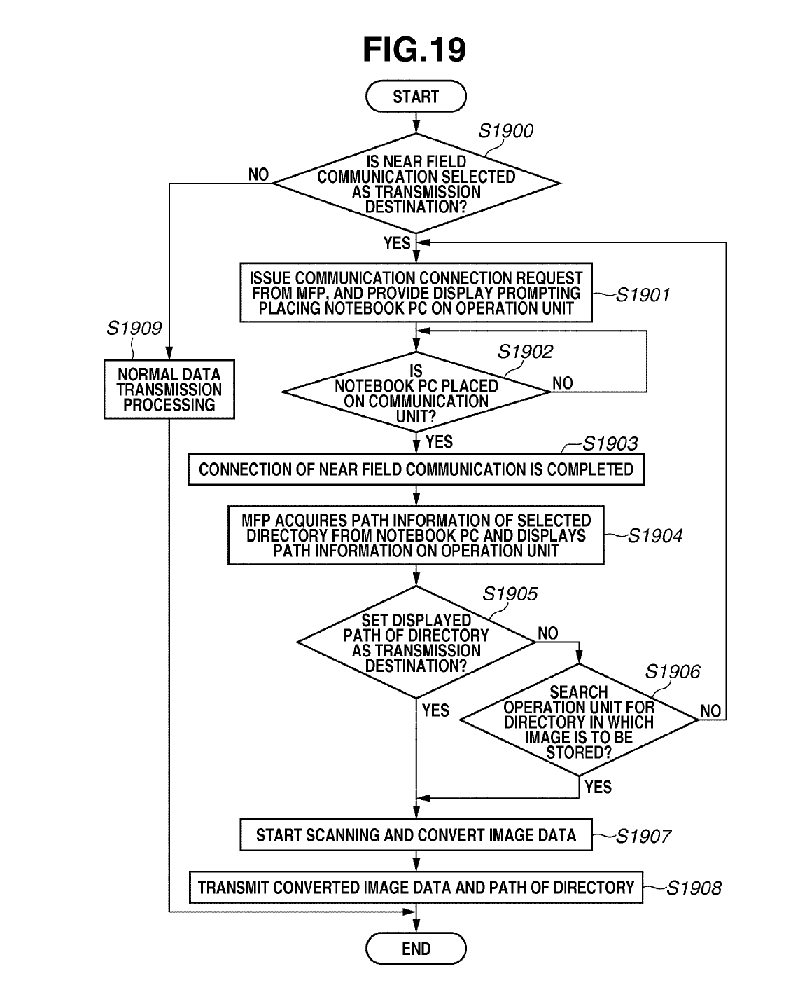

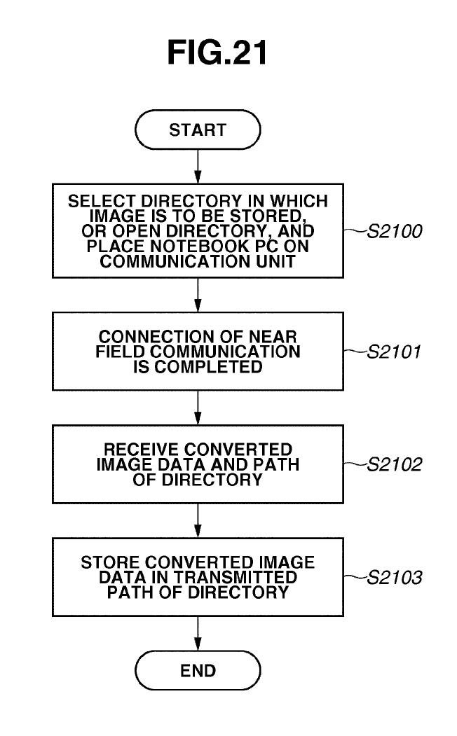

A series of flows in the image processing system applied to the exemplary embodiment of the present invention will be described with reference to the flowcharts of FIGS. 19 and 21. A procedure illustrated in the flowchart of FIG. 19 is stored in a storage medium of any one of the ROM 114, the DRAM 116, and the HDD 260 in the controller unit 110, and is executed by the CPU 112. A program illustrated in the flowchart of FIG. 21 is stored in a storage medium of any one of the ROM 2502, the HDD 2503, and the RAM 2504 in the notebook PC 1000, and is executed by the CPU 2501.

FIG. 19 illustrates an example of flow in the MFP 100 in a period elapsed since a document was scanned and converted into image data with a predetermined format in the reader format 200 until a storage location of the image data is intuitively designated and the image data is transmitted. A case where the image data is transmitted to the notebook PC 1000 from the MFP 100 is taken as an example.

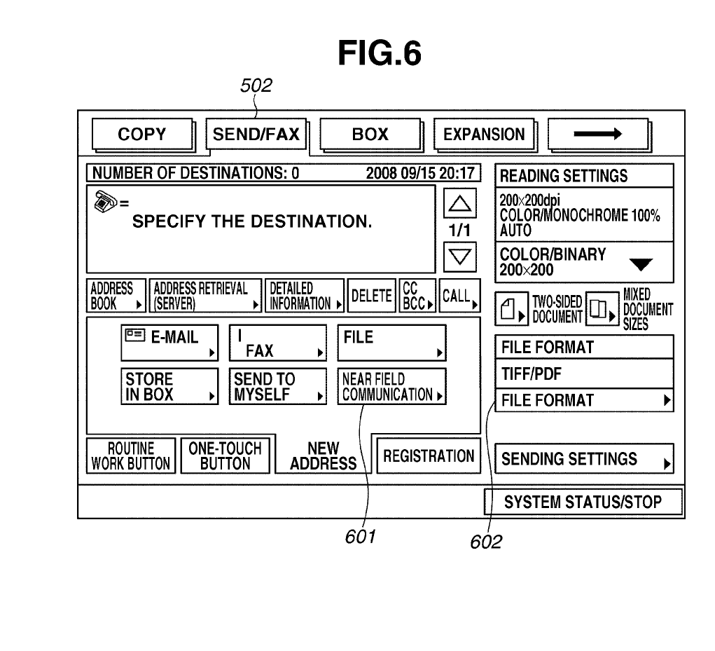

In step S1900, the CPU 112 first determines whether the user selects near field communication as a transmission destination in the data sending function. FIG. 6 illustrates a screen displayed on the touch panel section 401 after the send/fax key 502 is pressed in FIG. 5. Examples of transmission destinations in the data sending function and a facsimile include an electronic mail (e-mail), a file server, a box, an I facsimile, and near field communication, as illustrated in FIG. 6. It is possible to set the file format of image data into which a read image is to be converted in the reader unit 200 by selecting a file format 602. A file format such as a tagged image file format (TIFF) or a portable document format (PDF) is generally used.

If the user selects the transmission destination other than the near field communication (NO in step S1900), then in step S1909, normal data transmission processing is performed. On the other hand, if the user selects the near field communication (YES in step S1900), then in step S1901, the CPU 112 issues a communication connection request from the wireless communication unit 400 in the MFP 100, and provides display prompting the user to place a device at the transmission destination (the notebook PC in the present exemplary embodiment) on the touch panel section 401 in the operation unit 250.

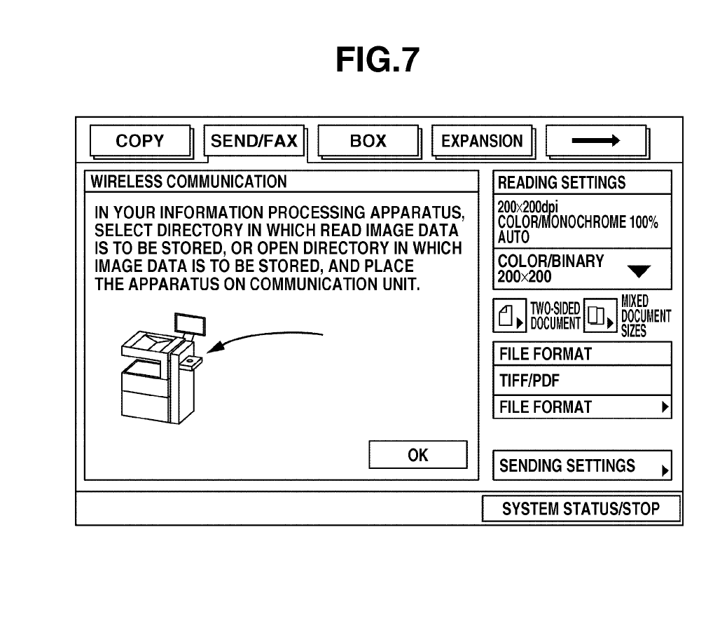

FIG. 7 illustrates an example of a screen displayed on the touch panel section 401 at this time. As illustrated in FIG. 7, a directory to be a storage location of image data read with the scanner is opened or selected before the notebook PC is placed on the communication unit 10 (the wireless communication unit 400).

In step S1902, the CPU 112 determines whether the user places the notebook PC on the communication unit 10. If the user places the notebook PC on the communication unit 10 (YES in step S1902), then in step S1903, connection of the near field communication is completed.

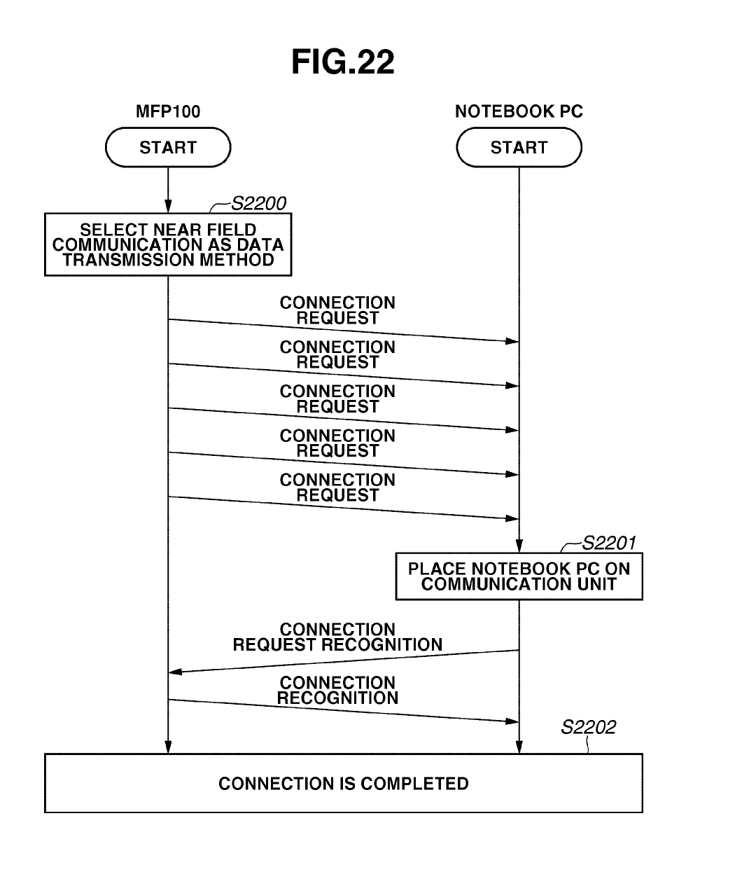

Transmission and reception of a signal between the MFP 100 and the notebook PC will be described with reference to FIG. 22. In step S2200, the user first selects near field communication as a data transmission method in the operation unit 250 in the MFP 100, as in step S1901. When the near field communication is selected, the wireless communication unit 400 transmits a connection request at predetermined intervals. The connection request is continued until the notebook PC 1000 at the transmission destination is placed on the wireless communication unit 400 or is brought closer thereto. In step S2201, the user places the notebook PC on the communication unit 10 (the wireless communication unit 400). When the notebook PC is placed on the communication unit 10, the notebook PC receives the connection request from the MFP 100, while conversely transmitting a connection request recognition at this time. Finally, the MFP 100 receives the connection request recognition, and then transmits a connection recognition serving as a final confirmation to the notebook PC. In step S2202, connection of the near field communication is completed, as in step S1903, after the notebook PC receives the connection recognition. This causes the near field communication to be started between the MFP 100 and the notebook PC. If the near field communication is started in step S1903, then in step S1904, the MFP 100 acquires information representing a path of a directory that is currently opened or selected in the notebook PC from the notebook PC via wireless communication, and then displays the acquired path of the directory on the touch panel section 401 in the operation unit 250.

In step S1905, the CPU 112 determines whether the path of the directory displayed on the touch panel section 401 is set as a transmission destination in the data sending function. If the displayed path of the directory is set as the transmission destination (YES in step S1905), then in step S1907, the user actually presses the start key 404, to start to scan a document. In step S1907, the CPU 112 in the MFP 100 converts the read image data into image data with a format selected by the user in the reader unit 200. In step S1908, the MFP 100 then transmits the converted image data and the path information of the directory that has just been acquired from the notebook PC to the notebook PC via the near field communication.

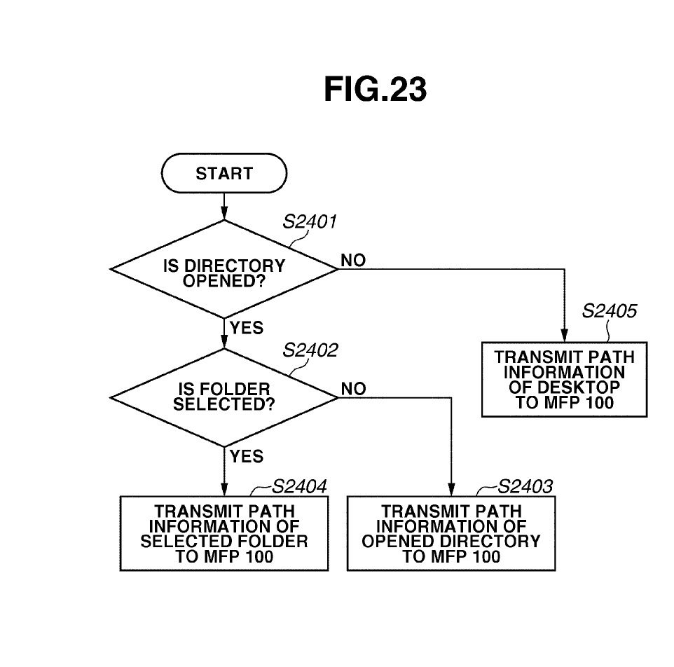

On the other hand, a series of processing flows in the notebook PC at this time will be described with reference to FIG. 21. In step S2100, the user first selects a directory in which image data to be read in the MFP 100 is to be stored, or opens the directory, and places the notebook PC on the communication unit 10. In step S2100, the CPU 2501 in the notebook PC detects that the notebook PC is placed on the communication unit 10 by receiving the connection request from the MFP 100. When the user places the notebook PC on the communication unit 10, the notebook PC transmits the connection request recognition to the MFP 100. If the notebook PC further receives the connection recognition from the MFP 100, then in step S2101, connection of the near field communication is completed, so that data can be transmitted and received. In step S2102, the notebook PC then acquires information representing a path of a directory representing a storage location and image data from the MFP 100, as illustrated in the flowchart of FIG. 23. In this case, the MFP 100 reads the image data, converts the image data into image data with a predetermined format, and then transmits the converted image data and the information representing the path of the directory to the notebook PC. In step S2103, the notebook PC finally stores the received image data in the received path of the directory. At this time, the notebook PC may create and store a new directory. The details thereof will be described below.

Although the series of processing flows in the present exemplary embodiment has been described with reference to the flowcharts of FIGS. 19 and 21, some cases are considered in terms of designating the directory in the notebook PC. Some of the cases will be described as examples.

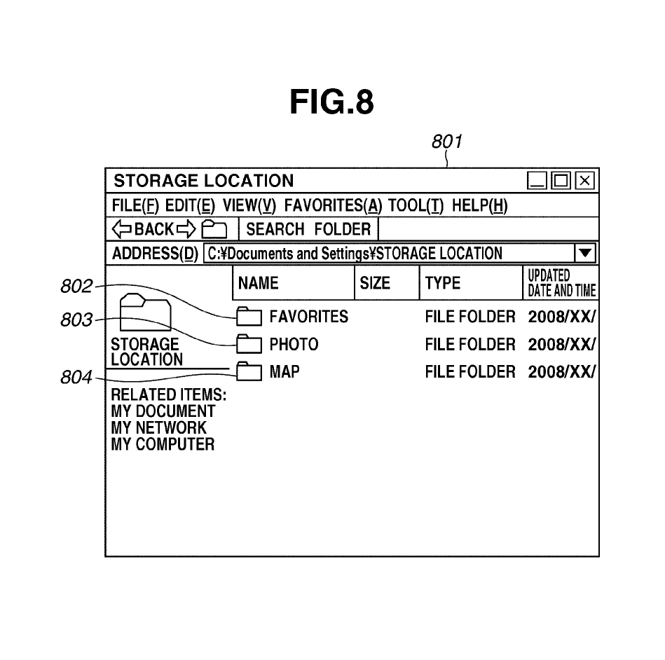

The cases will be described with reference to the flowchart of FIG. 23 and FIGS. 8 to 17. A procedure illustrated in the flowchart of FIG. 23 is executed by the CPU 2501 according to a program stored in a storage medium of any one of the ROM 2502, the HDD 2503, and the RAM 2504.

The flowchart of FIG. 23 is flow for the wireless communication I/F 2507 to transmit information relating to a storage location of the notebook PC to the MFP 100 by near field communication. When the near field communication is established, this flow is executed. Therefore, a user of the MFP 100 can store an image in a desired storage location of the notebook PC in a simple operation, described below. The CPU 2501 in the notebook PC determines whether a directory is opened in step S2401 or a folder is selected in step S2402, to execute the following cases.

<Case 1> Case where any Folder is not Selected with Directory Opened:

FIG. 8 illustrates the state of a display screen in the notebook PC in this case. Although a folder named “storage location” is opened, and the folder includes three folders 802 to 803, any of the folders is not selected in FIG. 8. However, a window of the folder “storage location” is selected, and a tool bar 801 is active.

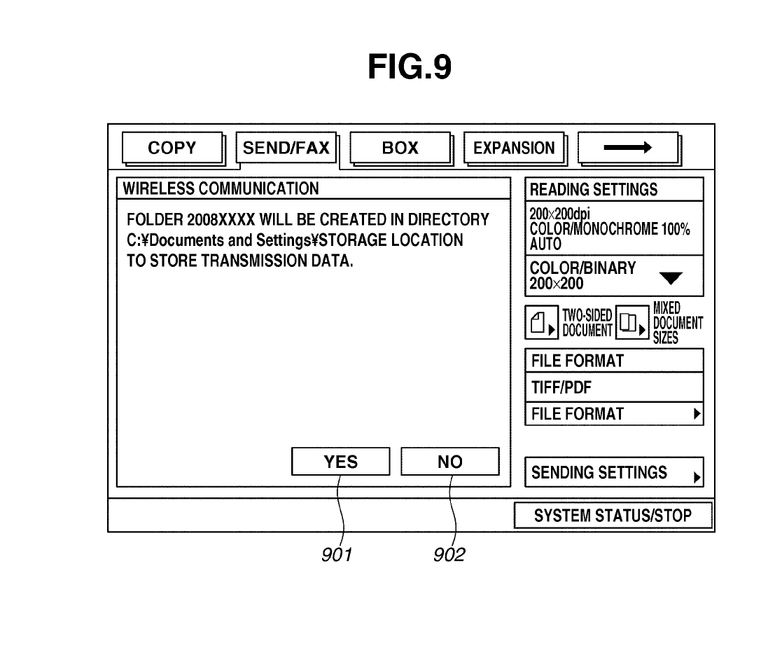

If the user places the notebook PC on the communication unit 10 in this state, then in step S2403, the notebook PC transmits information representing a path of an opened directory to the MFP 100. The MFP 100 acquires information representing a path of the folder “storage location” currently opened in the notebook PC. In step S1904, the MFP 100 then automatically provides display with a folder having a folder name for the date and time at which image data is to be stored, for example, just below the folder “storage location” as a storage destination. FIG. 9 illustrates an example of the display on the touch panel section 401 at this time. If a path of a directory illustrated in FIG. 9 is a desired transmission destination (YES in step S1905), the user presses a YES key 901, to actually start scanning.

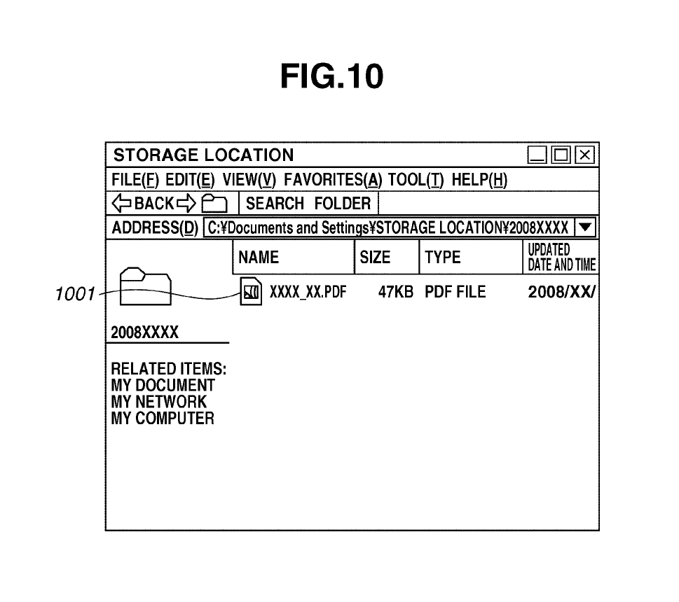

In step S2103, the notebook PC then receives converted image data and information representing a path of a directory from the MFP 100, and stores the image data in the path of the directory. FIG. 10 shows how the image data is stored in the notebook PC. As illustrated in FIG. 10, the notebook PC creates a folder named “2008XXXX” just below the folder “storage location”, and stores the image data in the folder “2008XXXX”. Although the name of the created folder is the date as an example, it may be the date and time. In addition thereto, the name may be uniquely identified.

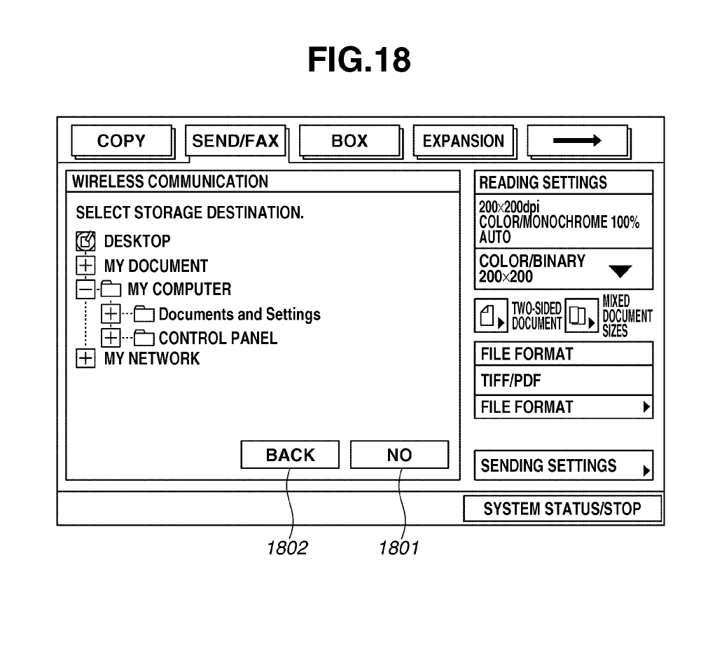

On the other hand, if the path of the directory displayed on the touch panel section 401 is not a desired transmission destination, and therefore the user presses a NO key 902 (NO in step S1905), then in step S1906, the user can search the touch panel section 401 for a directory hierarchy (a directory in which image data is to be stored) in the notebook PC. FIG. 18 illustrates an example of the display on the touch panel section 401 at this time. However, the user who feels that this search work is complicated can also designate a path in which image data is to be stored again by opening or selecting a desired directory in the notebook PC again to place the notebook PC on the communication unit 10.

<Case 2> Case where any Folder is Selected:

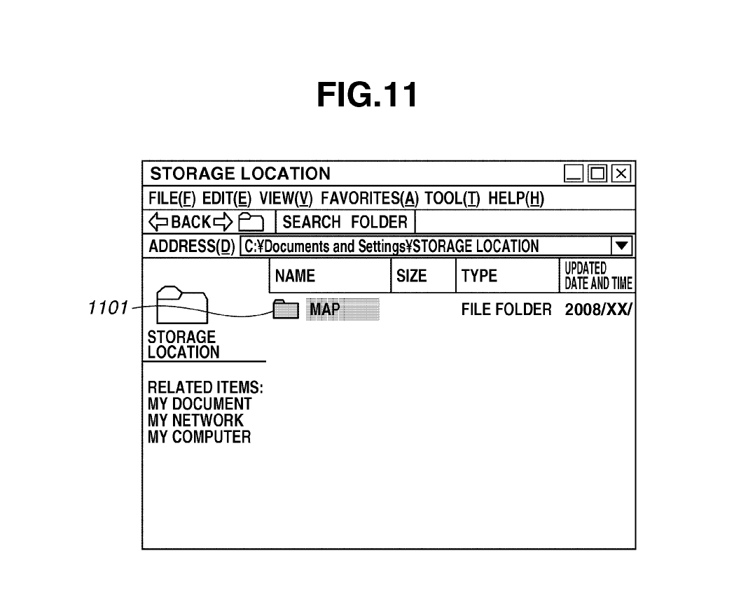

FIG. 11 illustrates the state of a display screen in the notebook PC in this case. As illustrated in FIG. 11, a folder named “storage location” is opened, and a folder 1101 named “map” in the folder is selected.

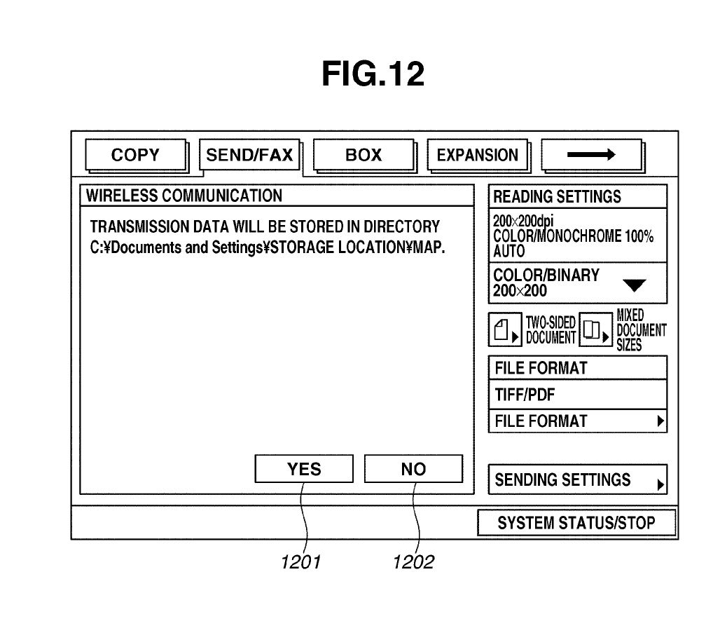

If the user places the notebook PC on the communication unit 10 in this state, then in step S2404, the notebook PC transmits information representing a path of the selected folder to the MFP 100. The MFP 100 acquires information representing a path of the folder “map” currently designated in the notebook PC. In step S1904, the MFP 100 then provides display with the path of the folder “map” as a storage destination. FIG. 12 illustrates an example of the display on the touch panel section 401 at this time. If a path of a directory illustrated in FIG. 12 is a desired transmission destination (YES in step S1905), the user presses a YES key 1201, to actually start scanning. When the user presses a NO key 1202, the flow is similar to that in the case 1.

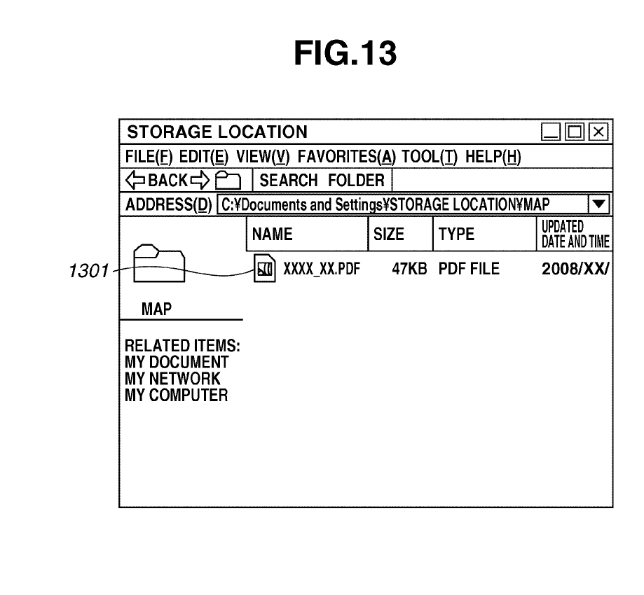

In step S2103, the notebook PC then receives converted image data and information representing a path of a directory from the MFP 100, and stores the image data in the path of the directory. FIG. 13 shows how the image data is stored in the notebook PC. As illustrated in FIG. 13, the notebook PC stores the image data in the folder “map” designated by the user.

<Case 3> Case where No Directory is Selected:

In this case, the user places the notebook PC on the communication unit 10 without designating a desired storage destination of image data.

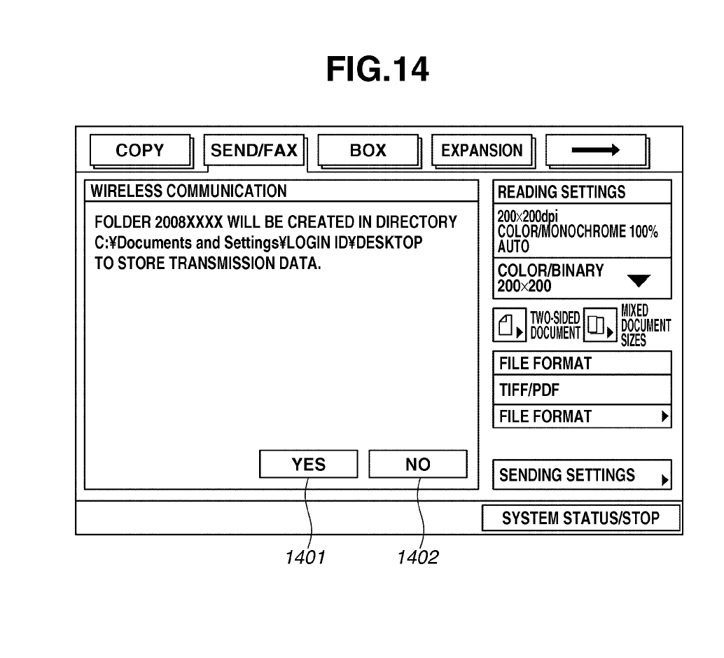

If the user places the notebook PC on the communication unit 10 in this state, then in step S2405, the notebook PC transmits information representing a path of “desktop” to the MFP 100. The MFP 100 acquires the path information of “desktop” in the notebook PC. In step S1904, the MFP 100 then automatically provides display with a path of a folder having a folder name for the date and time, for example, just below “desktop” as a storage destination. FIG. 14 illustrates an example of the display on the touch panel section 401 at this time. If a path of a directory illustrated in FIG. 14 is a desired transmission destination (YES in step S1905), the user presses a YES key 1401, to actually start scanning. When the user presses a NO key 1402, the flow is similar to that in the case 1.

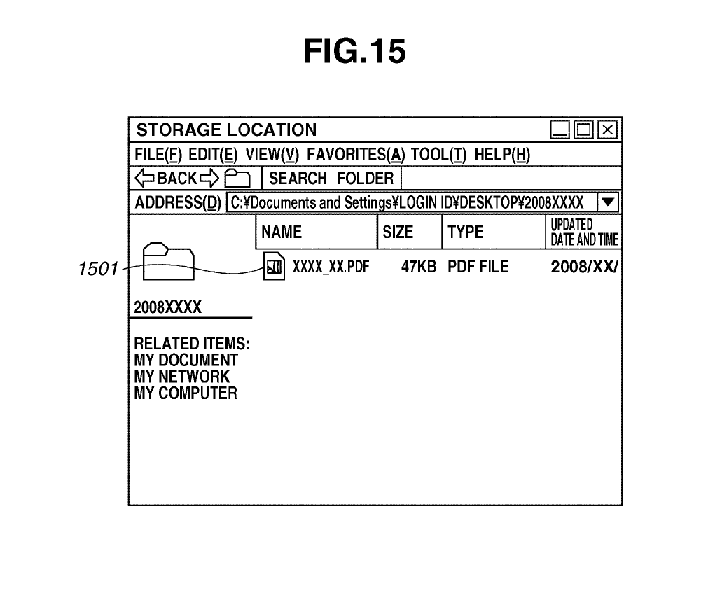

In step S2103, the notebook PC then receives converted image data and information representing a path of a directory from the MFP 100, and stores the image data in the path of the directory. FIG. 15 shows how the image data is stored in the notebook PC. As illustrated in FIG. 15, the notebook PC creates a folder named “2008XXXX” just below “desktop”.

<Case 4> Case where the User Designates a Plurality of Folders:

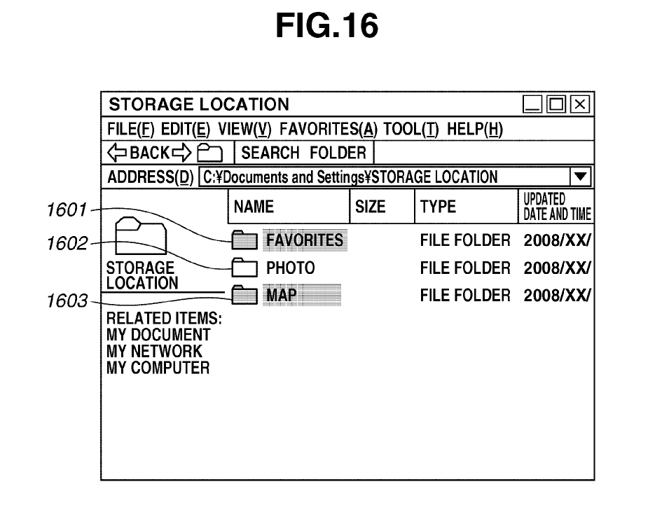

FIG. 16 illustrates the state of a display screen in the notebook PC in this case. As illustrated in FIG. 16, a folder named “storage location” is opened, and two folders 1601 and 1603 respectively named “favorites” and “map” in the folder are selected.

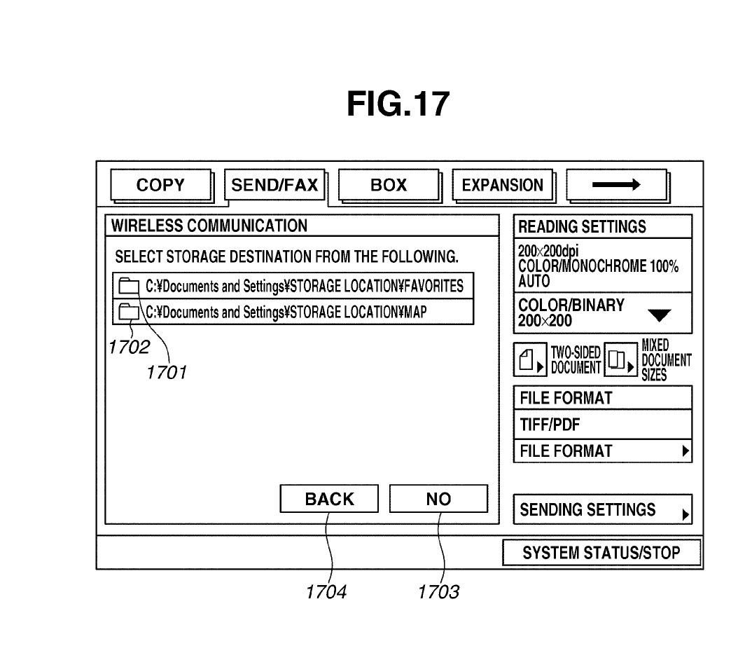

If the user places the notebook PC on the communication unit 10 in this state, the MFP 100 acquires respective information representing paths of the folders “favorites” and “map” currently selected in the notebook PC. In step S1904, the MFP 100 then provides display with the paths of the folders “favorites” and “map” as storage destinations, and causes the user to choose which of the folders stores image data. FIG. 17 illustrates an example of the display on the touch panel section 401 at this time. Then, the notebook PC stores the image data in the path of the directory selected in FIG. 17.

When connection of near field communication is thus completed between the notebook PC and the MFP 100, the notebook PC can simply transmit information relating to a storage location in the notebook PC to the MFP 100 depending on the status of the system being operated by the user.

As described above, according to the present exemplary embodiment, when the image data read in the MFP 100 is transmitted to the notebook PC 1000, the user can acquire the information relating to the storage destination in a very simple operation that is easy to intuitively understand. More specifically, the user can transmit the information relating to the storage destination only by opening the desired folder in the notebook PC and placing the notebook PC on the communication unit 10 in the MFP 100. The received image data can be also stored in the desired folder in the notebook PC. On the other hand, the MFP 100 can receive the information relating to the storage destination only by placing the notebook PC on the communication unit 10 in the MFP 100.

Although description has been made of an example in which the user places the notebook PC on the communication unit 10 in the MFP 100 so that the near field communication is started, the present invention is not limited to the same. The user may bring the notebook PC closer to the communication unit 10 in the MFP 100 so that the near field communication is started.

Although description has been made of an example in which the document placed in the reader unit 200 is scanned and transmitted, the present invention is not limited to the same. The present invention may be applied to a case where an image stored in a box within the HDD 260 is transmitted to the notebook PC using near field communication. In this case, the near field communication is selected with an image file stored in the HDD 260 or the box designated instead of placing the document in the reader unit 200. From this time on, processing illustrated in FIG. 19 will be performed. In this case, the document is not read. Therefore, transmitting data is only generated without starting scanning in step S1907.

Furthermore, although description has been made of an example in which the path information selected in the notebook PC is transmitted to the MFP 100, the user designates the path information on the MFP 100, and the image data, together with the path information, is transmitted, as illustrated in FIG. 23, the present invention is not limited to the same. When the notebook PC is placed on the communication unit 100 with the path information selected in the notebook PC, the notebook PC may not transmit and receive the path information to and from the MFP 100. In this case, the processing in step S1904 to step S1906 is not performed in the MFP 100. Similarly, the image data is only transmitted without transmitting and receiving the path information in step S1908. On the other hand, the notebook PC that has received the image data via the near field communication determines the storage destination of the image data received according to processing similar to that in the flowchart of FIG. 23. More specifically, information representing a path in which image data is to be stored is acquired, and the received image data is stored in the path based on whether a directory is opened or a folder is selected. In this case, the user of the MFP 100 can transmit a desired document to the notebook PC in a simple operation without being conscious of a storage location of the image data in the notebook PC.

A hardware configuration in a second exemplary embodiment of the present invention is similar to that in the first exemplary embodiment.

Although the MFP 100 issues the communication connection request at timing at which the near field communication 601 is selected as the transmission destination in the data sending function in the first exemplary embodiment, an example in which a document is actually scanned, data is converted, and a communication connection request is later issued will be described in the second exemplary embodiment.

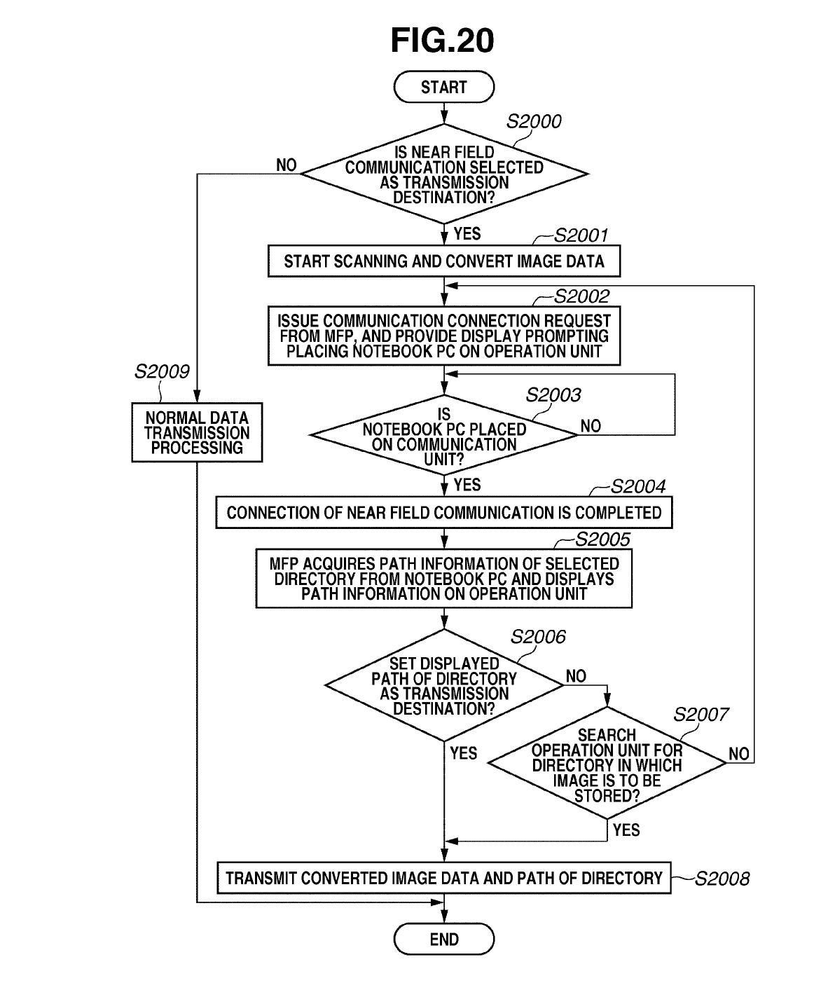

A series of flows in an image processing system applied to the exemplary embodiment of the present invention will be described with reference to the flowchart of FIG. 20. A procedure illustrated in the flowchart of FIG. 20 is stored in a storage medium of any one of a ROM 114, a DRAM 116, and A HDD 260 in a controller unit 110, and is executed by a CPU 112.

The difference between the flowchart of FIG. 19 and the flowchart of FIG. 20 is only that the MFP 100 issues a communication connection request to the notebook PC after starting scanning to perform data conversion for data transmission. In short, they only differ depending on whether timing at which the notebook PC is placed is before or after the document is scanned. If there are a large number of documents to be scanned, however, the notebook PC must be placed on the wireless communication unit 400 during the scanning in the first exemplary embodiment. It is not desirable that the notebook PC is placed on the wireless communication unit 400 over a longtime because the risks of the notebook PC being stolen and dropping from the wireless communication unit 400 are increased. Therefore, the MFP 100 will actually convert image data into image data with a desired file format, issue a communication connection request to the notebook PC after being ready for transmitting the data, and acquire information representing a path of a desired directory. This causes a period of time during which the notebook PC is placed on the communication unit 10 to be suppressed to the minimum required, thereby enabling an increase in the probability of avoiding various risks. The other processing flow is similar to that in the first exemplary embodiment.

Although description has been mainly made of the exemplary embodiments in the near field communication, the exemplary embodiment of the present invention is not limited to the same. The present invention is also applicable in various I/Fs.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-294597 filed Nov. 18, 2008, which is hereby incorporated by reference herein in its entirety.

What is claimed is:

1. An information processing apparatus for performing wireless communication with an image processing apparatus, the information processing apparatus comprising:
a specifying unit configured to designate, out of a plurality of directories stored in the information processing apparatus, an opened directory before performing wireless communication with the image processing apparatus;
a receiving unit configured to receive image data from the image processing apparatus by performing the wireless communication; and
a control unit configured to control the image data received by the receiving unit to be stored in the directory designated by the specifying unit.

2. The information processing apparatus according to claim 1, wherein the specifying unit designates a particular storage location when the opened directory does not exist.

3. The information processing apparatus according to claim 2, wherein the particular storage location is a desktop in the information processing apparatus.

4. The information processing apparatus according to claim 1, wherein the information processing apparatus detects that the image processing apparatus is brought closer thereto, to start the wireless communication.

5. An image processing apparatus for performing wireless communication with an information processing apparatus, the image processing apparatus comprising;
a storage unit configured to store image data;
an acquiring unit configured to acquire, out of a plurality of directories stored in the information processing apparatus, information representing an opened directory from the information processing apparatus in response to start of the wireless communication with the information processing apparatus; and
a transmitting unit configured to transmit the image data stored in the storage unit to the information processing apparatus to store the image data in the directory represented by the information acquired by the acquiring unit.

6. A computer readable storage medium storing a program for controlling an image processing apparatus for performing wireless communication with an information processing apparatus, the program comprising:
a code to store image data in a storage unit;
a code to acquire, out of a plurality of directories stored in the information processing apparatus, information representing an opened directory from the information processing apparatus in response to start of the wireless communication with the information processing apparatus; and
a code to transmit the image data stored in the storage unit to the information processing apparatus to store the image data in the directory represented by the acquired information.
